(19) United States
(12) Patent Application Publication
(10) Pub. No.: US 2006/0276088 A1
(43) Pub. Date: Dec. 7, 2006

(54) Profiled Structural Concrete Fiber Material And Building Products Including Same, And Methods

(75) Inventor: Michael L. DeWeese, Kingman, KS (US)

Correspondence Address: VALERIE CALLOWAY;CHIEF INTELLECTUAL PROPERTY COUNSEL, POLYMER GROUP, INC., 9335 HARRIS CORNERS PARKWAY SUITE 300, CHARLOTTE, NC, 28269, US

(73) Assignee: POLYMER GROUP, INC., Mooresville, NC (US)

(21) Appl. No.: 11/421,638

(22) Filed: Jun. 1, 2006

Related U.S. Application Data
(60) Provisional application No. 60/686,151, filed on Jun. 1, 2005.

(51) Int. Cl. B32B 5/02

(52) U.S. Cl. 442/59

(57) ABSTRACT

A synthetic fiber material made with multipolymer blends which have been fibrillated in oriented film form is provided that is useful as a secondary reinforcement material, which has a low Young's modulus for a more uniform distribution throughout a cementitious mixture incorporating the fiber material, and imparts good finishability, strength, and improved plastic shrinkage crack control, in addition to providing improved conformability within cementitious forms, especially within forms comprising bends equal to or greater than about 45 degrees. Improved cementitious compositions and fiber-reinforced concrete building products incorporating the synthetic fiber materials are also provided, as well as methods for making the synthetic fiber materials.

### CROSS-REFERENCE TO RELATED APPLICATIONS

This applications claims priority under 35 U.S.C. §119(e) to U.S. Provisional Application No. 60/686,151, filed Jun. 1, 2005, which is hereby incorporated by reference in its entirety.

### TECHNICAL FIELD

The present invention generally relates to a synthetic reinforcement fiber material for cementitious mixtures, and more specifically relates to a fibrillated fiber material useful as a secondary reinforcement material, wherein the fibrillated fiber material exhibits a low Young's modulus for a more uniform distribution throughout a cementitious mixture, good strength, finishing ease, and improved plastic shrinkage crack control, in addition to improved conformability within cementitious forms comprising bends equal to or greater than about 45 degrees. The present invention additionally relates to building products containing the synthetic fiber material, and methods of making the synthetic fiber material.

### BACKGROUND OF THE INVENTION

Many proposals have been made to reinforce, strength, or otherwise beneficially alter the properties of cementitious mixtures by applying and/or incorporating various types of fibrous components, including asbestos, glass, steel, as well as synthetic polymer fibers to aqueous based concrete mixes prior to the curing of the concrete. The types of polymer fibers in use or proposed for use include those composed of natural and synthetic composition. Exemplarily reinforcement fiber is disclosed in U.S. Pat. No. 6,071,613, No. 6,197,423, No. 6,265,056, and No. 6,503,625, all of which are hereby incorporated by reference.

The two forms of fibers currently used in producing concrete reinforcement from synthetic substrates include crack reduction from elastic shrinkage and secondary reinforcement for structural performance. Crack reduction is obtained by using “simple” synthetic fibers, wherein the performance of reducing cracks is inherent to any hydrophilic fiber used in the mixture. Secondary structural reinforcement is obtained in a synthetic substrate through materials having performance attributes above those required in a simple crack reduction product.

Rapid loss of water, thermal degradation, constraint due to forms/molds, poor bleed (e.g., high fines, low water, high air, etc.) and settlement during plastic phase early in cure of concrete mixes can contribute to stressors. Small stressors in regions of concrete can induce micro-cracks. Micro cracks are unsightly initially and can be catalytic to future, more significant issues, such as permeation, freeze/thaw, corrosion, spalling, and so forth. Fibers have been introduced into the concrete mix in efforts to allow for bridging of micro-crack prior to propagation. Structural fibers exhibit a suitable tensile strength sufficient to “bridge” a forming crack and retain overall performance of the concrete despite the failure in the cementitious mixture. As a constant force is applied to a cast and cured cementitious construct comprising reinforcing fiber, the construct is sustained under an increasing level of structural stress. As the strain increases further, the matrix of the construct can not withstand the structural stress, and the matrix begins to fail usually in the form of a micro-crack. However, the reinforcing fibers act to bridge the micro-crack, and the construct is able to maintain integrity during additional stress. As the strain increases yet further, one of two general results occur. Either the reinforcing fiber begins to lose its interfacial bonding to the matrix, and begins slipping, which will result in decreasing strength benefit or the fiber tensile strength is exceeded and breaks in the region of the expanding crack, which will also results in decreasing strength benefit.

Existing structural fibers such as type 1 steel, type 2 steel, Forta Ferro® fibers and Strux® fibers exhibit very high resistance to deflection. Resistance to deflection, measured as Young's modulus, results in numerous issues in handling and resulting performance, such as difficulty loading into forms. Rigid reinforcing fibers that are resistant to deflection can be difficult to uniformly disperse in a concrete matrix, and the aggregate may take on a false alignment. They also tend to nest or bridge at necking points or tight regions of primary reinforcement to hinder proper and complete filling of a concrete mold or former. Such fibers are also difficult to conform to bends, which results in non-uniform distribution in bends in cementitious forms of greater than 45 degrees, and to the point of near zero distribution in bends of greater than 90 degrees. Further, such fibers make cementitious forms difficult to finish. Often, either enhanced finishing techniques or grinding or burning is necessary to rid of reinforcing fiber extending beyond the surface of the concrete.

The cementitious reinforcement materials of the prior art have exchanged increased tensile strength for higher resistance to deflection, which in turn, has resulted in fiber that do not distribute effectively in concrete that is under highly stringent forming conditions. A need remains for a structural reinforcement fiber that exhibits strength and improved flexibility, as well as the ability to distribute more uniformly through a cementitious mixture.

### SUMMARY OF THE INVENTION

The present invention is directed to a fibrillated synthetic fiber material useful as a secondary reinforcement material, wherein the fibrillated synthetic fiber material exhibits a low Young's modulus for a more uniform distribution throughout a cementitious mixture, and imparts good finishability, strength, and improved plastic shrinkage crack control, in addition to providing improved conformability within cementitious forms, especially within forms comprising bends equal to or greater than about 45 degrees.

In accordance with one embodiment of the present invention, the synthetic reinforcement fiber material comprises a multi-polymer blend of a first polymer comprising polypropylene and a second polymer selected from polyethylene and polystyrene, wherein the synthetic fiber material has undergone at least 5% fibrillation per square inch. In a preferred embodiment, the fibrillated synthetic fiber material has the physical form of a fibrous network in an open lace or webbed configuration. “Fibrillation per square inch” is defined herein as the area of synthetic fiber material comprising mechanical impaction resulting in a lace-like structure. Loose or disconnected (at one free end) laterally extending interconnecting strands within the lace-like structure may exist to the extent of about 1% to about 5% of the interconnecting strands, although not limited thereto.

In a further embodiment, the synthetic fiber material provides a residual strength per ASTM C1399 of at least 190 pounds per square inch (psi) at 5 pounds (lbs.) per cubic yard loading at 8 days cure, a residual strength per ASTM C1399 of at least 140 psi at 4 lbs. per cubic yard loading at 8 days cure, and/or a residual strength per ASTM C1399 of at least 110 psi at 3 lbs. per cubic yard loading at 8 days cure.

The above-mentioned synthetic fiber material preferably exhibits a Young's modulus at 30% elongation of between 5.5 and 9.5 gigapascals (Gpa), and more preferably in the range of between 6.5 and 8.5 Gpa, and most preferably between 7.0 and 8.0 Gpa. Further still, the above-referenced synthetic fiber material preferably has a thickness of between 1.0 and 3.5 mil (mil=0.001 inch), and with a more preferred range of 1.25 to 3.0 mil. Other features and advantages of the present invention will become readily apparent from the following detailed description and the appended claims.

As other embodiments, improved hydratable cementitious compositions and fiber-reinforced concrete building products incorporating the synthetic fiber materials are also provided, as well as methods for making the synthetic fiber materials.

For purposes of this application, “Young's modulus” refers to a measure of the stiffness of a given material. It is defined as the limit, for small strains, of the rate of change of stress with strain. This can be determined, for example, from the slope of a stress-strain curve created during tensile tests conducted on a sample of the material.

### BRIEF DESCRIPTION OF THE DRAWINGS

FIG. 1 is a process flow diagram of a method for making a fibrillated synthetic fiber material according to an embodiment of the invention.

FIG. 2 is a process flow diagram of a method of using the fibrillated synthetic fiber material made according to the method of FIG. 1 in the preparation of a cementitious building material according to an embodiment of the invention.

FIG. 3 is a plot of average residual strength at two different loading (dosage) levels for synthetic fiber material representative of an embodiment of the present invention.

FIG. 4 is a plot of average residual strength for synthetic fiber material representative of an embodiment of the present invention and several comparative commercial fiber products.

FIG. 5 is a plot of compressive strength for synthetic fiber material representative of an embodiment of the present invention and several comparative commercial fiber products.

FIG. 6 is a plot of slump for synthetic fiber material representative of an embodiment of the present invention and several comparative commercial fiber products.

### DETAILED DESCRIPTION

While the present invention is susceptible of embodiment in various forms, there is shown in the drawings, and will hereinafter be described, a presently preferred embodiment, with the understanding that the present disclosure is to be considered as an exemplification of the invention, and is not intended to limit the invention to the specific embodiment illustrated.

In accordance with the present invention, the synthetic reinforcement fiber exhibits improved flexibility (i.e., less rigidity) and strength, as well as endowed with inherent and improved dispensability and dispersability into organic or inorganic cementitious matrices, such as concrete, mortar, plaster, etc. The synthetic fiber material can impart improved shrinkage and settlement crack control in concrete building forms and products. The synthetic fiber material also is highly compatible with finishing operations performed on the reinforced concrete form.

Resin Composition. In a preferred embodiment, the synthetic fiber reinforcement material is made with a resin composition comprising a combination of two or more different synthetic polymers, such as, for example, a physical mixture or resinous “alloy” of polyolefins such as a mixture of polypropylene and polyethylene, or alternatively a mixture of polypropylene and polystyrene, that provide better pull-out resistance from hydratable cementitious matrix materials (e.g., ready mix concrete). In a preferred embodiment, the synthetic fiber material is made exclusively or essentially exclusively with a polypropylene/polyethylene blend alone, or alternatively a polypropylene/polystyrene blend alone, and in the absence of additives or other forms of polymeric ingredients, as the resin composition that is processed as described herein. The polypropylene may be used as a single type or combined types of polypropylene. The polypropylene preferably may comprise combined usage of a highly isotactic polypropylene homopolymer and a high molecular weight polypropylene homopolymer having a significantly lower melt flow rate as compared to the highly isotactic polypropylene homopolymer. In a preferred embodiment, the resin composition is a ternary multipolymer physical blend or combination of polymer components comprising (a) a highly isotactic polypropylene homopolymer, (b) high molecular weight polypropylene homopolymer of significantly or substantially lower melt flow rate than the first-mentioned type of polypropylene, and (c) high strength linear polyethylene. For instance, the highly isotactic polypropylene homopolymer may have a melt flow rate of about 3.8 to about 4.2 g/10 min (ASTM D1238, I₂ at 230° C.), a density of about 0.89 to 0.91 g/cm³, and elongation at yield (ASTM D638, 50 mm/min) of about 8 to about 10%. The high molecular weight polypropylene homopolymer may have a melt flow rate of about 0.4 to about 0.6 g/10 min (ASTM D1238, I₂ at 230° C.), a density of about 0.89 to 0.91 g/cm³, and elongation at yield (ASTM D638, 50 mm/min) of about 8 to about 10%. Therefore, highly isotactic polypropylene resin (a) may be used in the resin composition which has a melt flow rate (ASTM D1238, 230° C.) that is about 6 to about 10 times higher (i.e., about 6× to about 10× higher), particularly, about 7 to about 9 times higher, than that of the polypropylene resin (b). The high strength linear polyethylene may have a melt flow rate of about 0.9 to about 1.1 g/10 min (ASTM D1238, 190° C./2.16 kg), a density of about 0.91 to 0.93 g/cm³, and elongation at break (ASTM D882) of about 725% to about 775% (M.D.) and about 975% to about 1000% (T.D.). The proportions of the above-mentioned three polymer components (a), (b) and (c) of a preferred resin composition may comprise component (a) in a major amount, and components (b) and (c) each are present in a minor amount, relative to the total resin composition. In a particular non-limiting embodiment, the resin composition may comprise about 60% to about 90% polymer component (a), about 10% to about 30% polymer component (b), and about 1% to about 10% polymer component (c), all on a weight percentage basis. Multipolymer blends such as described in U.S. Pat. Nos. 6,592,790 and 6,503,625, the disclosures of which are hereby incorporated by reference, also may be suitable as the resin composition. Although not desiring to be bound to theory, it is surmised that different moduli of the different types of polymers physically admixed in the resin composition increases the opportunity of obtaining the variable width or thickness dimensions and surface deformation desired. Also, the use of multipolymer fibers better demonstrate the superiority of the methods of the present invention when compared to the prior art clinker-intergrinding process, such as described by U.S. Pat. No. 5,298,071, because the destruction and shredding of multipolymer fibers is highly discernable both to the naked eye and under microscopic magnification.

For film formation, the resin composition, as a polyolefin stock material (e.g., pellets, powders, etc.), is heated, mixed and extruded into a thin film, such as using conventional methods and equipment used for that general purpose.

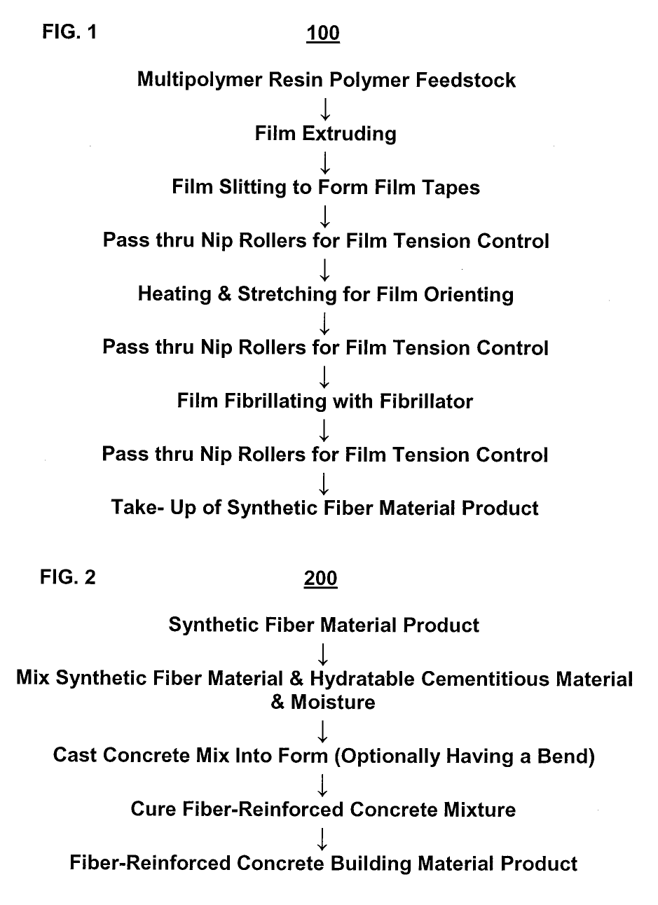

Fibrillation. Referring to FIG. 1, a process 100 of fibrillating the polyolefin film includes the steps of (a) longitudinally slitting the extruded film into long generally flat tapes, ribbons or strips; (b) stretching the film tapes to orient the polymer chain or crystal structure to be aligned in the direction of the advancement of the film tapes (i.e., uniaxially orient the film); and (c) subjecting the oriented film tapes to impaction by various means to fracture the film of each tape and transform the film tape into a fibrous network representing the fibrillated synthetic fiber material product of the invention. The film slitting provides long tapes, ribbons, or strips of film each having a width which generally may be, for example, about 12 mm to about 26 mm, although not limited thereto. Film orientation is typically accomplished by stretching the tapes using rollers that are rotating at different surface speeds as the tapes are passed through an oven or other film heating means at elevated temperature. For example, the tapes may be heat-stretched for orientation with a stretch ratio in the range of about 4.5:1 to about 12.5:1 to produce an oriented film of about 1.0 to about 3.5 mil thickness. Film tension may be effected by passing the film through nip rollers or similar means in advance of and after the heating oven to control tension on the tapes during their transit through the heating means. The oriented tapes are then interacted with impaction means effective to fibrillate each of the tapes of film into an individual fibrous network structure. The means used to impact the oriented films may include fluids such as water or gas jets, blades, pins, toothed projections, laser beams, twisting of the orientated films, embossing of the orientated films, and embossing of the films prior to orientation. Basic methods of fibrillation are taught, for example, in U.S. Pat. Nos. 3,958,599; 4,009,812; and 4,129,632, the disclosures of which are hereby incorporated by reference. Enhanced results may be obtained using mechanical fibrillation means, such as, for example, described in U.S. Pat. Nos. 3,302,501, 3,496,260 and 3,550,826, the disclosures of which are hereby incorporated by reference. However, other fibrillation methods may also be used, such as, for example, fluid and sonic fibrillation, e.g., see U.S. Pat. Nos. 3,423,888 and 3,345,242, the disclosures of which are hereby incorporated by reference. Mechanical fibrillation, for example, pin (sometimes referred to as “needle”) process involves using a pin ring or pin bar designed specifically to fit either a solid steel machined arbor or a solid steel machined slotted arbor. The mechanically driven arbor with pins is commonly known as a fibrillator. Slit tapes, either fully oriented (drawn) or partially oriented are positioned across the fibrillator, under tension, to enable either full or partial pin penetration. A tensioning means, such as a guide roller or nip rollers, located ahead of the fibrillator, anchor(s) the film tapes as they are drawn or pulled over the pinned surface of the fibrillator. The oriented film also may be passed around part of the periphery of a pinned fibrillating roller (e.g., see U.S. Pat. Nos. 3,880,173 and 5,104,367, the disclosures of which are hereby incorporated by reference).

Where using a pinned fibrillation means, pin spacing in each row (e.g., pins per cm), pin density (e.g., pins per cm²), and pin rate (e.g., differential speed of pins versus speed of slit tapes) can vary greatly depending upon method of pin alignment and/or consolidation. Pin spacing, for example, may be ≧8 pins/cm, pin density may be ≧3.5 pins per square cm, and a pin rate may be ≧30 percent (based on 100× ratio value of speed of pins/speed of slit tapes). Preferred pin spacing, for example, is ≧10 pins/cm, pin density of ≧5.5 pins per square cm, and a pin rate of ≧40 percent. Although not desiring to be bound to any particular theory, it is thought that use of the higher pin density and higher pin rate of embodiments of the present invention yields finer interconnecting strands in the lace or net-like fibrous network product of the above-described fibrillation process, providing a more flexible and conformable, less rigid, fibrous reinforcing material without compromising adequacy in fiber strength for cementitious material environments.

The pins preferably may be arranged in a uniform or substantially uniform continuous pattern around the peripheral surface of the fibrillator. For example, a plurality of the pins may be arranged in respective fixed locations evenly spaced apart from one another in substantially straight rows extending transverse to the machine direction and in columns extending in alignment with the machine direction, around the peripheral surface of a rotary member of the fibrillator. The rake angle of the pins (i.e., the angle of pins to tangent with roller or other support in opposite direction to that of roller rotation) may vary between about 60 to about 90 degrees. The pin diameter and pin projection amount can comprise conventional dimensions or those otherwise suitable for the fibrillating function performed on particular film types and thicknesses thereof.

The fibrillated synthetic fiber material obtained from the fibrillator may be cut into convenient discrete lengths for the intended use. For cementitious material reinforcement, the synthetic fiber material may be cut in lengths, for example, of about 19 to about 25 mm, particularly about 32 to about 50 mm, although not limited thereto.

The fibrous network created at the fibrillation stage of the process is characterized by a macroscopically visible open lace-like or net-like structure. In one embodiment, this lace-like structure comprises a plurality of generally longitudinally-extending strands and a plurality of interconnecting strands that extend across lateral spaces between main strands and interconnect different main strands at spaced apart locations along the lengths of the main strands. The synthetic fiber material preferably has undergone at least 5% fibrillation per square inch, as defined above. In a particular embodiment, the interconnecting strands join the longitudinally-extending strands at substantially regular spaced intervals. Loose or disconnected (at one free end) laterally extending interconnecting strands within the lace-like structure may exist to the extent of about 1% to about 5% of the interconnecting strands, although not limited thereto.

In a particular embodiment of the present invention, the synthetic fiber material provides a residual strength per ASTM C1399 of at least 190 psi at 5 lbs. per cubic yard loading at 8 days cure, a residual strength per ASTM C1399 of at least 140 psi at 4 lbs. per cubic yard loading at 8 days cure, and a residual strength per ASTM C1399 of at least 110 psi at 3 lbs. per cubic yard loading at 8 days cure. Additionally, in a preferred embodiment, the synthetic fiber material exhibits a Young's modulus at 30% elongation of between 5.5 and 9.5 Gpa, and preferably in the range of between 6.5 and 8.5 Gpa, and most preferably between 7.0 and 8.0 Gpa. In another preferred embodiment, the above synthetic fiber material generally has a thickness of between 1.0 and 3.5 mil, and more preferably is in the range of 1.25 to 3.0 mil.

Improved hydratable cementitious compositions and fiber-reinforced concrete building products incorporating the synthetic fiber materials are also provided within additional embodiments of the invention. FIG. 2 shows an exemplary process 200 for using the synthetic fiber material made according to FIG. 1 in preparing a concrete mix that is formed and cured to provide an improved fiber-reinforced concrete building product. The cement mix can include portland cement and/or other hydratable cementitious material. It may be in dry or wet forms. The synthetic fiber material of embodiments of the present invention can be separately packaged, such as in concrete degradable bags, for introduction into a concrete mix at any time before, during or after concrete mixing. The synthetic fiber material can be introduced into and dispersed with ready mixed concrete, such as by using conventional concrete mix agitating or stirring means and methods before the mix sets and hardens. Alternatively, the synthetic fiber material can be pre-packaged as a mixture with one or more other concrete mix components, such as Portland cement and the like and/or other concrete ingredients, such as, e.g., supplementary cementitious materials (e.g., fly ash, slag, etc.), aggregates (e.g., sand, gravel, crushed stone, etc.), and/or conventional chemical admixtures used for concrete (e.g., air-entraining admixtures, accelerating admixtures, corrosion inhibitors, etc.). Concrete products of embodiments of the present invention generally may be a mixture of aggregates, paste and the synthetic fiber material. The paste, typically comprised of cement and water, binds the aggregates (usually sand and gravel or crushed stone) into a rocklike mass as the paste hardens because of the chemical reaction of the cement and water. Supplementary cementitious materials and chemical admixtures may also be included in the paste. The synthetic fiber material of the present invention can be dosed in concrete at rates of at least about 1.5 pound per cubic yard, and may range between about 1.5 to about 7.5 pounds per cubic yard, although the preferred amount may vary depending on the particular application. The synthetic fiber materials particularly may be used in precast and slab on ground Among other improvements, the concrete building product has improved micro-crack control (against propagation) while maintaining good conformability and strength contribution from the synthetic fiber material of embodiments herein. The concrete form also has good finishability as the synthetic fiber material is conducive to finishing operations.

The examples that follow are intended to further illustrate, and not limit, embodiments in accordance with the invention. All percentages, ratios, parts, and amounts used and described herein are by weight unless indicated otherwise.

### EXAMPLES

### Example 1

A synthetic fiber material (designated “SF” for purposes of this example) representing an embodiment of the present invention was prepared and its average residual strength, compressive strength and slump properties were evaluated as compared to several commercial reinforcing fiber products.

To prepare samples of the synthetic fiber material “SF”, a polypropylene/polyethylene resin blend was film extruded, uniaxially oriented, fibrillated, and cut to discrete length. The fibrillation process included use of mechanical fibrillation means having the general layout of the above-mentioned U.S. patents pertaining to mechanical fibrillation systems, with the adaptation/modification including the use of a pin spacing of ≧10 pins/cm, a pin density of ≧5.5 pins per square cm, and a pin rate of ≧40 percent, providing fibrous lace-like product having at least 5% fibrillation per square inch.

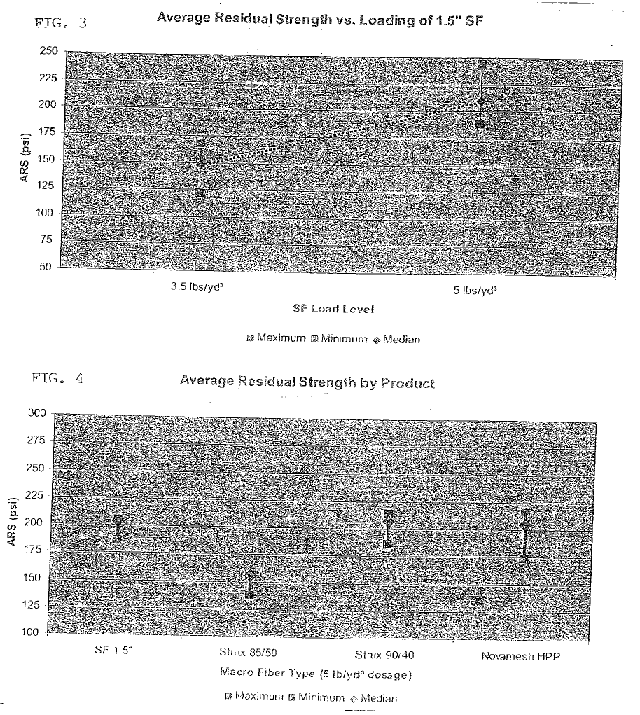

FIG. 3 shows the average residual strength in psi (ARS) at two different loading (dosage) levels for the inventive SF fiber material (1.5″) at 3.5 and 5 lbs./cubic yard dosage, as evaluated according to ASTM Test Method C1399.

FIG. 4 is a plot of average residual strength for synthetic fiber material SF representative of an embodiment of the present invention and several comparative commercial fiber products consisting of Strux® 85/50, Strux® 90/40, and SI Novamesh HPP.

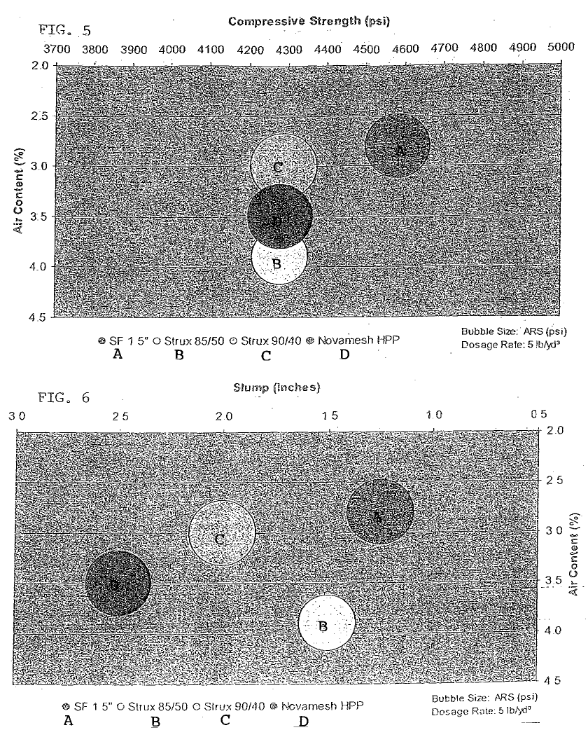

FIG. 5 is a plot of compressive strength, as measured by ASTM Designation: C39/C39M-04a, “Standard Test Method for Compressive Strength of Cylindrical Concrete specimens”, for synthetic fiber material SF (“A”) representative of an embodiment of the present invention and several comparative commercial fiber products consisting of Strux® 85/50 (“B”), Strux® 90/40 (“C”), and SI Novamesh HPP (“D”). For purposes of this plot, as well as that for FIG. 6, it will be appreciated that the circles plotted in the graphs generally represent the average of three data points obtained for each different type of reinforced product material under evaluation.

FIG. 6 is a plot of slump, as measured by ASTM Designation: C143/C143M-03, “Standard Test Method for Slump of Hydraulic-Cement Concrete”, for synthetic fiber material SF (“A”) representative of an embodiment of the present invention and several comparative commercial fiber products consisting of Strux® 85/50 (“B”), Strux® 90/40 (“C”), and SI Novamesh HPP

As seen in these results, the inventive SF fiber material exhibits improved compressive strength and comparable strength and slump as compared to the commercial fibrous reinforcing products.

From the foregoing, it will be observed that numerous modifications and variations can be affected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

What is claimed:

1. A synthetic fiber material comprising a multi-polymer blend containing a first polymer comprising polypropylene and a second polymer selected from polyethylene and polystyrene, and wherein the synthetic fiber material having undergone at least 5% fibrillation per square inch.

2. A synthetic fiber material as in claim 1, wherein the multi-polymer blend comprises (a) a highly isotactic polypropylene homopolymer, (b) high molecular weight polypropylene homopolymer of substantially lower melt flow rate than (a), and (c) high strength linear polyethylene.

3. A synthetic fiber material as in claim 1, wherein said synthetic fiber material exhibits a residual strength per ASTM C1399 of at least 190 psi at 5 lbs. per cubic yard loading at 8 days cure.

4. A synthetic fiber material as in claim 1, wherein said synthetic fiber material exhibits a residual strength per ASTM C1399 of at least 140 psi at 4 lbs. per cubic yard loading at 8 days cure.

5. A synthetic fiber material as in claim 1, wherein said synthetic fiber material exhibits a residual strength per ASTM C1399 of at least 110 psi at 3 lbs. per cubic yard loading at 8 days cure.

6. A synthetic fiber material as in claim 1, wherein said synthetic fiber material exhibits a Young's modulus at 30% elongation of between 5.5 and 9.5 Gpa.

7. A synthetic fiber material as in claim 1, wherein said synthetic fiber material has a thickness of between 1.0 and 3.5 mil.

8. A synthetic fiber material as in claim 1, wherein the synthetic fiber material comprises a fibrous network have a laced configuration.

9. A cementitious composition containing a hydratable cementitious material and a synthetic fiber material according to claim 1.

10. The cementitious composition of claim 9, wherein the multi-polymer blend comprises (a) a highly isotactic polypropylene homopolymer, (b) high molecular weight polypropylene homopolymer of substantially lower melt flow rate than (a), and (c) high strength linear polyethylene.

11. The cementitious composition of claim 9, wherein the curable cementitious material comprises portland cement.

12. The cementitious composition of claim 9, wherein said synthetic fiber material exhibits a Young's modulus at 30% elongation of between 5.5 and 9.5 Gpa.

13. The cementitious composition of claim 9, wherein said synthetic fiber material has a thickness of between 1.0 and 3.5 mil.

14. A fiber reinforced concrete building product containing a matrix comprising the cured product of a mixture including hydratable cementitious material and moisture, and a synthetic fiber material dispersed within the matrix, wherein said synthetic fiber material comprises a multi-polymer blend containing a first polymer comprising polypropylene and a second polymer selected from polyethylene and polystyrene, and wherein the synthetic fiber material having undergone at least 5% fibrillation per square inch.

15. The fiber reinforced concrete building product of claim 14, wherein the multi-polymer blend comprises (a) a highly isotactic polypropylene homopolymer, (b) high molecular weight polypropylene homopolymer of substantially lower melt flow rate than (a), and (c) high strength linear polyethylene.

16. The fiber reinforced concrete building product of claim 14, further comprising at least a first body portion and a second body portion generally oriented along respective first and second non-parallel planar directions, and said first and second body portions being connected by a bend arcing through an angle of at least 45 degrees (absolute) relative to at least one of the first and second planar directions.

17. The fiber reinforced concrete building product of claim 14, wherein said synthetic fiber material exhibits a residual strength per ASTM C1399 of at least 190 psi at 5 lbs. per cubic yard loading at 8 days cure.

18. The fiber reinforced concrete building product of claim 14, wherein said synthetic fiber material exhibits a residual strength per ASTM C1399 of at least 140 psi at 4 lbs. per cubic yard loading at 8 days cure.

19. The fiber reinforced concrete building product of claim 14, wherein said synthetic fiber material exhibits a residual strength per ASTM C1399 of at least 110 psi at 3 lbs. per cubic yard loading at 8 days cure.

20. The fiber reinforced concrete building product of claim 14, wherein said synthetic fiber material exhibits a Young's modulus at 30% elongation of between 5.5 and 9.5 Gpa.

21. The fiber reinforced concrete building product of claim 14, wherein said synthetic fiber material has a thickness of between 1.0 and 3.5.

22. A method of making fibrillated synthetic fiber material, comprising:
heating and stretching a tape of extruded film comprising a multi-polymer blend containing a first polymer comprising polypropylene and a second polymer selected from polyethylene and polystyrene, effective to orient the film in the direction of advancement;
passing the oriented tape around and in contact with part of the periphery of a pinned rotary member having pin density of at least about 3.5 pins per square cm and at a pin rate of at least about 30 percent, effective to provide a synthetic fiber material having undergone at least 5% fibrillation per square inch.

23. The method of claim 22, wherein the pin density is at least about 5.5 pins per square cm and the pin rate is at least about 40 percent.
